(19) United States
(12) Patent Application Publication
(10) Pub. No.: US 2015/0219263 A1
(43) Pub. Date: Aug. 6, 2015

(54) Flange and Adapter for Dual-Walled Tube Assembly

(71) Applicant: Electro-Motive Diesel, Inc., LaGrange, IL (US)

(72) Inventor: Jeffrey P. Nowak, Munster, IN (US)

(73) Assignee: Electro-Motive Diesel, Inc., LaGrange, IL (US)

(21) Appl. No.: 14/171,133

(22) Filed: Feb. 3, 2014

(51) Int. Cl. F16L 39/02; B23K 31/02

(52) U.S. Cl. CPC F16L 39/02; B23K 31/02

(57) ABSTRACT

A dual-walled flange assembly is disclosed that includes a body with an opening that extends through the body. The body further includes a sleeve that extends outward from one side of the body for being received in a fitting. The other side of the body is connected to an outer tube that encircles the opening as well as an inner tube that is received in the opening. An annulus is formed between the inner and outer tubes and at least one through hole extends from one side of the body, between the inner and outer tubes, through the body and at least partially into an outer surface of the sleeve. The through hole provides a leakage path between the inner tube and the annulus disposed between the inner tube and the outer tube.

### BACKGROUND

1. Technical Field

Disclosed herein are dual-walled flanges for dual-walled supply lines configured and designed to supply fuel or other hazardous fluids. Furthermore, methods for manufacturing such dual-walled flanges are also disclosed.

2. Description of the Related Art

Dual-walled tubing systems or coaxial tubing systems are used to convey fluid from one location to another. Dual-walled tubing systems include an inner tube disposed within and an outer tube. In one example, fluid may be conveyed through the inner tube while the outer tube contains any fluid that escapes from the inner tube. While dual-walled tubing systems may be used to convey many types of fluid, they are particularly useful for conveying fuels, hazardous liquids, toxic gases, etc. Dual-walled tubing systems are available in a variety of different sizes. Such dual-walled tubing systems may also be employed to convey two fluids, such as a first fluid conveyed through the inner tube and a second fluid conveyed through the annulus between the inner and outer tubes.

When used as a natural gas supply tine, dual-walled tubing systems may prevent leakage of natural gas into the atmosphere in case of damage to the inner tube, a seal or a weld. The outer tube may contain the gas leaking from the inner tube. However, the inner and outer tubes may be connected to various end fittings or flanges that connect the inner and outer tubes to a crankcase or other device. Currently, no flange or end fitting designs exist that convey leakage from the inner tube to the outer tube and that are easy to manufacture and install.

### SUMMARY OF THE DISCLOSURE

In one aspect, a flange is disclosed which may include a body having a first side and a second side with an opening extending from the first side to the second side. The body may further include a sleeve connected to and extending outward from the second side of the body. The sleeve may have an inner surface that encircles the opening as well as an outer surface. The body may include at least one through hole disposed radially outside of the opening and in radial alignment with the outer surface of the sleeve. The at least one through hole may extend from the first side of the body at least partially into the outer surface of the sleeve thereby providing communication between the first side of the body and the outer surface of the sleeve.

In another aspect, a dual-walled flange assembly is disclosed. The disclosed assembly may include a body having a first side and a second side with an opening extending from the first side to the second side. The body may further include a sleeve connected to and extending outward from the second side of the body. The sleeve may have an inner surface that encircles the opening and an outer surface. The body may include at least one through hole disposed radially outside of the opening and in radial alignment with the outer surface of the sleeve. The at least one through hole may extend from the first side of the body at least partially into the outer surface of the sleeve. The assembly may further include an inner tube having one end mateably received in the opening and another end extending outward from the first side of the body. The assembly may further include an outer tube that encircles at least part of the inner tube and the at least one through hole. The outer tube may have one end coupled to the first side of the body and another end extending outward from the first side of the body. The at least one through hole may provide communication between the first side of the body and the outer surface of the sleeve.

In another aspect, a method is disclosed for fabricating a dual-walled flange assembly for a sealed connection between coaxial inner and outer tubes and a fitting. The method may include forming a unitary body including a first side and a second side with an opening extending from the first side to the second side. The body may further include a sleeve connected to an extending outward from the second side of the body. The sleeve may have an inner surface that encircles the opening and an outer surface. The sleeve may be sized to be mateably received in the fitting. The method may further include forming at least one through hole disposed radially outside of the opening and in radial alignment with the outer surface of the sleeve. The at least one through hole may extend from the first side of the body at least partially into the outer surface of the sleeve thereby providing communication between the first side of the body and the outer surface of the sleeve. The method may further include providing an inner tube sized to be mateable received in the opening and providing an outer tube sized to encircle the inner tube and the at least one through hole. The method may further include connecting one end of the outer tube to the first side of the body with the at least one through opening and the inner tube disposed radially within the outer tube.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiment illustrated in greater detail on the accompanying drawings, wherein:

FIG. 1 is a sectional view of a disclosed flange connected to an inner tube and an outer tube.

FIG. 2 is a rear perspective view of the flange disclosed in FIG. 1.

FIG. 3 is a front perspective view of the flange disclosed in FIGS. 1 and 2.

FIG. 4 is a front plan view of the flange disclosed in FIGS. 1-3.

FIG. 5 is a sectional view taken substantially along line 5-5 of FIG. 4.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

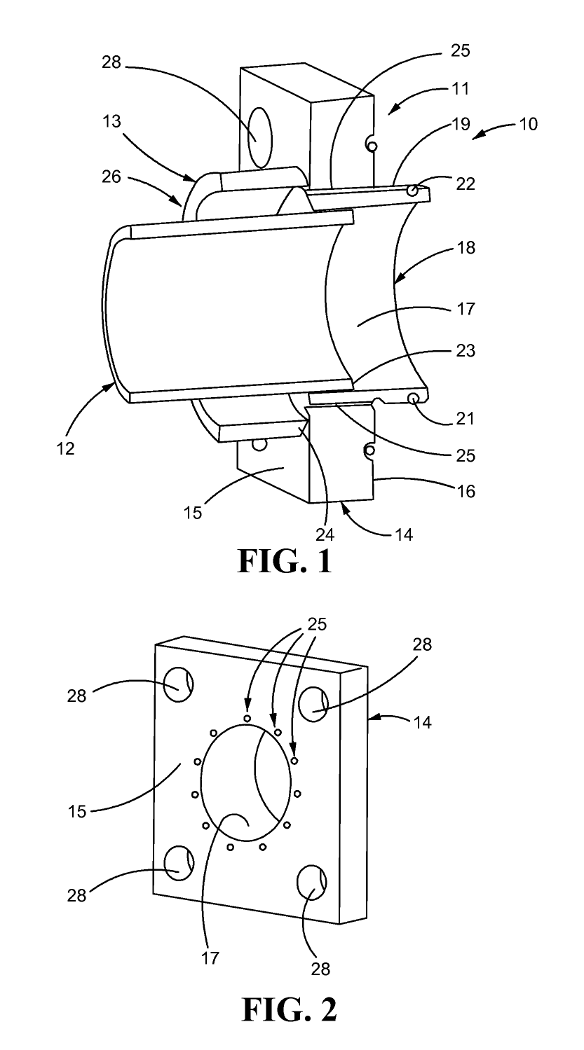

Turning to FIG. 1, a sectional view of a dual-walled flange assembly 10 is shown that illustrates a disclosed flange 11 connected to an inner tube 12 and an outer tube 13.

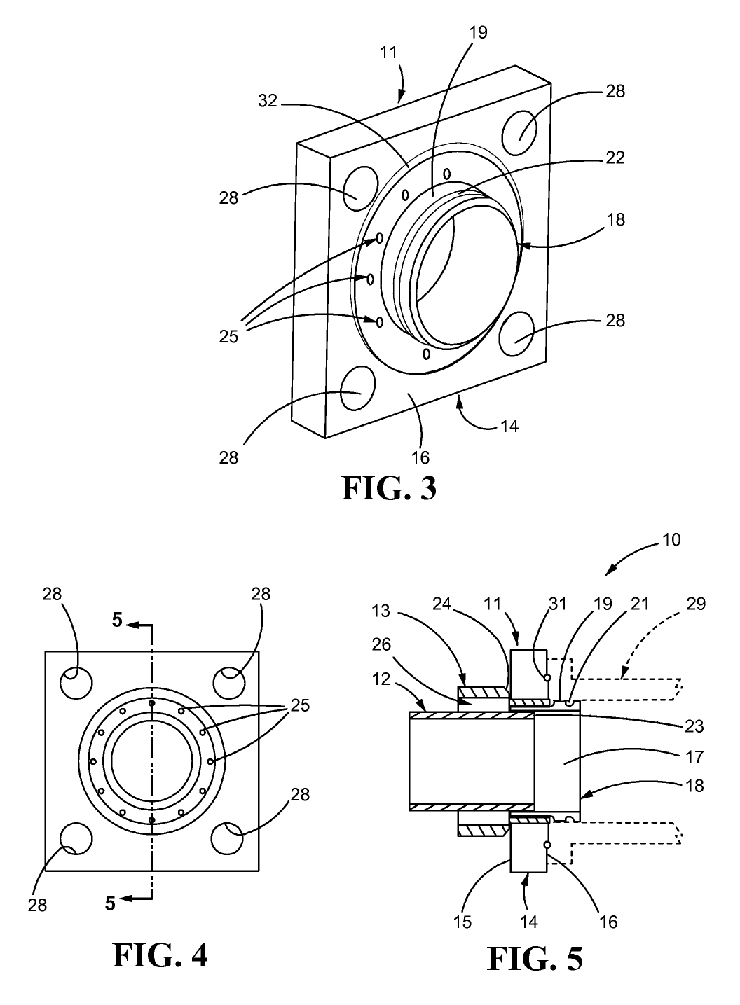

The flange 11 may include a body 14 having a first side 15 and a second side 16. An opening 17 may extend from the first side 15 to the second side 16 as illustrated in FIG. 2. Returning to FIG. 1, a sleeve 18 may extend outward from the second side 16 of the body 14. The sleeve 18 may be an extension of the opening 17. As best seen in FIG. 5, the outer surface 19 of the sleeve 18 may include a peripheral slot 21 for accommodating a static seal 22 (see also FIGS. 1 and 3). The seal 22 may serve to seal a connection between the sleeve 18 and a fitting (not shown) such as a fitting to an engine.

The inner tube 12 may be sized to be accommodated in the opening 17. The inner tube 12 may be secured in place by welding the inner tube 12 to the opening 17 or to an inner surface of the sleeve 18. The weld may be disposed at the proximal end 23 of the inner tube 12 and the opening 17. In contrast, the outer tube 13 may be secured to the first side 15 of the body 14 of the flange 11. More specifically, the weld may be disposed at the junction of the proximal end 24 of the outer tube 13 and the first side 15 of the body 14.

Turning to FIG. 2, a plurality of through holes 25 may be disposed around the opening 17. Two through holes 25 are illustrated in FIG. 1. The through holes 25 extend from the first side 15 of the body 14 at least partially into the outer surface 19 of the sleeve 18. Thus, the through holes 25 provide a leakage path between the second side 16 and the first side 15 of the body 14. More specifically, the through holes 25 provide a leakage path to the annular space 26 disposed between the outer tube 13 and the inner tube 12. The extension of the through holes 25 at least partially into the outer surface 19 of the sleeve 18 is further illustrated in FIG. 3. While the embodiment illustrated in FIGS. 1-5 includes twelve through holes 25 that extend through the body 14, the number of through holes 25 may vary from just a single through hole 25 to more or less than twelve through holes 25. As shown in FIGS. 1-4, the body 14 may include a plurality of bolt holes 28 for securing the flange 11 or the flange assembly 10 to a fitting such as the one shown in phantom lines in FIG. 5.

Returning to FIG. 3, in addition to the static seal 22 disposed on the outer surface 19 of the sleeve 18, the second side 16 of the body 14 may further include a slot 31 (see FIG. 5) for accommodating a face seal 32 (see FIG. 3) that, in use, may be sandwiched between the fitting 29 and the second side 16 of the body 14 as illustrated in FIG. 5. As also illustrated in FIG. 5, an appropriate weld between the proximal end 24 of the outer tube 13 and the first side 15 of the body 14 may be a butt weld while one appropriate weld between the proximal end 23 of the inner tube 12 and the opening 17 or the sleeve 18 may be a transverse fillet weld. Other suitable welding techniques will be apparent to those skilled in the art.

### INDUSTRIAL APPLICABILITY

A flange 11 for connecting coaxial or dual tubes 12, 13 to a female fitting 29 is disclosed. The flange 11 includes one or more through holes 25 that extend from a first side 15 of the flange body 14 to a second side 16 of the flange body 14. The through holes 25 may be used to convey leakage from the inner tube 12 to an annulus 26 disposed between the inner tube 12 and the outer tube 13. The outer tube 13 contains any leakage from the inner tube 12 and the through holes 25 convey that leakage through the annulus 26 instead of allowing leaked fluid or gas from escaping the piping and leaking into an airbox and/or the atmosphere. The sleeve 18 that extends outward from the second side 16 of the flange body 14 may optionally include a static seal on its outer surface 19 and the second side 16 of the flange body 14 may accommodate a face seal 32. Thus, the disclosed flange 11 acts to contain leakage from the inner tube 12 as well as any leakage from the fitting 29, which may be an airbox crankcase or another fitting on an engine, generator, etc.

The disclosed flange 11 may be formed using known manufacturing techniques. A unitary body 14 may be formed as illustrated in FIGS. 2-3. Then, one or more through holes 25 may be formed radially outside of the opening 17 but in radial alignment with the outer surface 19 of the sleeve 18. Then, the appropriate size tubes 12, 13 are provided and the inner tube 12 may be welded to the opening 17 and the outer tube 13 may be welded to the first side 15 of the flange body 14. The through holes 25 may provide communication between the annulus 26 disposed between the inner tube 12 and outer tube 13 and the second side 16 of the flange body 14.

What is claimed:

1. A flange comprising:
a body having a first side and a second side with an opening extending from the first side to the second side,
the body further including a sleeve connected to and extending outward from the second side of the body, the sleeve having an outer surface that encircles the opening,
the body including at least one through hole disposed radially outside of the opening and in radial alignment with the outer surface of the sleeve, the at least one through hole extending from the first side of the body at least partially into the outer surface of the sleeve thereby providing communication between the first side of the body and the outer surface of the sleeve.

2. The flange of claim 1 wherein the first side of the body includes a flat portion disposed radially outside of the opening and the through hole that encircles the through hole and opening.

3. The flange of claim 1 wherein the at least one through hole includes a plurality of through holes that encircle the opening and that are in radial alignment with the outer surface of the sleeve.

4. The flange of claim 1 wherein the inner surface of the sleeve is in matching registry with the opening.

5. The flange of claim 1 wherein the outer surface of the sleeve accommodates a static seal.

6. The flange of claim 5 wherein the static seal is an O-ring.

7. The flange of claim 1 wherein the second side of the body accommodates a face seal that encircles the sleeve and the at least one through hole.

8. The flange of claim 7 wherein the face seal is an O-ring.

9. The flange of claim 1 wherein the body and sleeve are unitary in structure.

10. A dual-walled flange assembly, comprising:
a body having a first side and a second side with an opening extending from the first side to the second side,
the body further including a sleeve connected to and extending outward from the second side of the body, the sleeve having an outer surface that encircles the opening,
the body including at least one through hole disposed radially outside of the opening and in radial alignment with the outer surface of the sleeve, the at least one through hole extending from the first side of the body at least partially into the outer surface of the sleeve,
an inner tube having one end mateably received in the opening and another end extending outward from the first side of the body,
an outer tube that encircles at least part of the inner tube and the at least one through hole, the outer tube having one end coupled to the first side of the body and another end extending outward from the first end of the body,
wherein the at least one through hole providing communication between the first side of the body and the outer surface of the sleeve.

11. The flange assembly of claim 10 wherein the at least one through hole includes a plurality of through holes that encircle the opening and that are in radial alignment with the outer surface of the sleeve and that are disposed radially between the inner tube and the outer tube.

12. The flange assembly of claim 10 wherein the inner surface of the sleeve is in matching registry with the opening.

13. The flange assembly of claim 10 wherein the outer surface of the sleeve accommodates a static seal.

14. The flange assembly of claim 13 wherein the static seal is an O-ring.

15. The flange assembly of claim 13 wherein the second side of the body accommodates a face seal that encircles the sleeve and the at least one through hole.

16. The flange assembly of claim 15 wherein the face seal is an O-ring.

17. The flange assembly of claim 15 wherein the body and sleeve are unitary in structure, the inner is welded in the opening of the body and the outer tube is welded to the first side of the body.

18. A method for fabricating a dual-walled flange assembly for a sealed connection between inner and outer tubes and a fitting, the method comprising:
forming a unitary body including a first side and a second side with an opening extending from the first side to the second side, the body further including a sleeve connected to and extending outward from the second side of the body, the sleeve having an outer surface that encircles the opening, the sleeve being sized to be mateably received in the fitting;
forming at least one through hole disposed radially outside of the opening and in radial alignment with the outer surface of the sleeve, the at least one through hole extending from the first side of the body at least partially into the outer surface of the sleeve thereby providing communication between the first side of the body and the outer surface of the sleeve;
providing an inner tube sized to be mateably received in the opening through the first side of the body;
connecting one end of inner tube in the opening;
providing an outer tube sized to encircle the inner tube and the at least one through hole; and
connecting one end of the outer tube to the first side of the body with the at least one through opening and inner tube disposed radially within the outer tube.

19. The method of claim 18 further including forming a plurality of through holes that encircle the opening and that are in radial alignment with the outer surface of the sleeve.

20. The method of claim 18 further including forming a peripheral slot in the outer surface of the sleeve for accommodating a static seal; and
forming a circular slot in the second side of the body that encircles the sleeve for accommodating a face seal.
